(19) United States
(12) Patent Application Publication
(10) Pub. No.: US 2020/0149603 A1
(43) Pub. Date: May 14, 2020

(54) ROTOR BRAKE OVERHEAT MANAGEMENT DEVICE

(71) Applicant: Ratier-Figeac SAS, Figeac (FR)

(72) Inventor: Bertrand PROUZET, FIGEAC (FR)

(21) Appl. No.: 16/532,757

(22) Filed: Aug. 6, 2019

(30) Foreign Application Priority Data
Nov. 12, 2018 (EP) 18306482.3

(51) Int. Cl. F16D 65/847; F16D 55/36; B64C 27/12

(52) U.S. Cl. CPC F16D 65/847; F16D 2065/781; B64C 27/12; F16D 55/36

(57) ABSTRACT

There is provided a heatsink for a brake calliper. The heatsink includes a hollow base and an intermediate material provided in the hollow base.

### FOREIGN PRIORITY

This application claims priority to European Patent Application No. 18306482.3 filed Nov. 12, 2018, the entire contents of which is incorporated herein by reference.

### TECHNICAL FIELD

The examples described herein relate to devices and methods for managing overheating of a rotor brake. In particular, these devices and methods may be used in a rotor brake of a helicopter.

### BACKGROUND

Typically, when a helicopter engine is switched off, the rotor of the helicopter quickly decelerates to half of the nominal speed for flight due to the torque generated by rotor blade drag. After this, the drag torque on the rotor blades is much lower and several minutes are needed to fully stop the rotor. In normal use, a helicopter rotor brake is used to reduce the time needed to fully stop the rotor. This is typically known as ‘nominal braking’. In an emergency situation, the helicopter rotor brake may be activated when the helicopter engines are switched off and the rotor is still at nominal speed. This is typically known as ‘emergency braking’. During emergency braking, the energy absorbed by the brakes is approximately four times the energy absorbed during nominal braking.

Helicopter rotor brakes are normally located on a helicopter upper deck close to the engines and other hydraulic circuits. If a leakage occurs from one of these circuits, hydraulic fluid may be sprayed on to the brake. This is hazardous in that the fluid may ignite if in contact with hot parts of the brake during braking. In order to avoid ignition of fluid, the external surface of the brake should not exceed the ignition temperature of the fluid during nominal or emergency braking. If the brake does exceed the ignition temperature of the fluid, a fire on the helicopter may occur.

One way to avoid fluid ignition is to isolate the brake inside a protective box made of refractory materials. However, in these systems the internal parts of the brake may reach higher temperatures and this reduces performance and reliability of the internal parts. Further, isolating the brake means that the brake takes longer to cool down and therefore it is necessary to wait before the engine of the helicopter can be restarted.

Another way to avoid fluid ignition is to install a heatsink in the brake calliper. The heatsink is typically sized to dissipate the heat from the brake such that the external surface of the brake does not reach temperatures that cause the fluid to ignite even for emergency braking. The heatsink is therefore sized in order to be able to dissipate four times the nominal braking energy. Cooling fins used in such heatsinks require a lot of volume to dissipate the heat making the installation of the heatsink and the brake calliper more difficult. Due to the large size of the heatsink, there is a significantly greater overall weight of the braking system.

### SUMMARY OF THE INVENTION

In one example, there is provided a heatsink for a brake calliper. The heatsink includes a hollow base and an intermediate material provided in the hollow base.

The heatsink may further include a plurality of cooling fins located adjacent the hollow base.

Further, the intermediate material may be configured to melt above a temperature of the environment during normal braking operation and below a temperature of the environment during emergency braking operation so as to absorb thermal energy. The melting temperature of the intermediate material is preferably above 520 Kelvin and below 575 Kelvin.

Preferably, the intermediate material may consist of at least one of a metallic alloy, polymer and/or chemical salt.

The hollow base may preferably be surrounded by a refractory housing.

The heatsink may also include internal fins that extend into the intermediate material.

In another example, there is provided a brake calliper. The brake calliper includes a rotor blade, a shaft connected to the rotor blade, a rotor brake connected to the shaft and a heatsink as described above connected to the rotor brake.

Preferably, the brake calliper may further include a plurality of discs adjacent a first side of the hollow base, a plurality of cooling fins adjacent a second side of the hollow base, a first plurality of internal fins extending into the intermediate material from the first side of the hollow base and a second plurality of internal fins extending into the intermediate material from the second side of the hollow base.

In another example, there is provided a method of transferring thermal energy from a brake calliper during an emergency brake operation. The method includes providing a heatsink, wherein the heatsink includes a hollow base. The method further includes providing an intermediate material in the hollow base, wherein, during an emergency brake operation, the intermediate material melts to absorb thermal energy from the brake calliper.

### BRIEF DESCRIPTION OF THE DRAWINGS

FIG. 1 shows the basic features of a standard helicopter with a braking system.

FIG. 2 shows a known braking calliper with a heat sink.

FIG. 3A shows an example of a braking calliper with a new heat sink as described herein.

FIG. 3B shows the heatsink assembly of the braking calliper shown in FIG. 3A.

FIG. 4 depicts a graph of a latent fusion heat effect.

### DETAILED DESCRIPTION

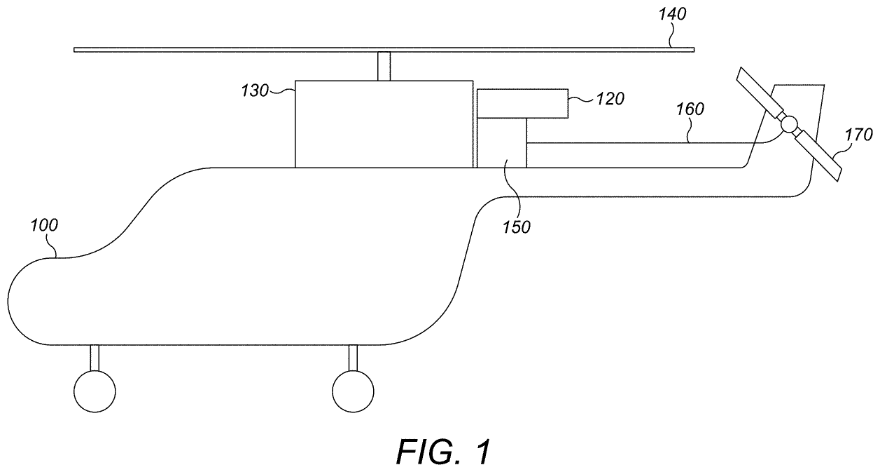

An overview of a helicopter 100 is shown in FIG. 1, which depicts the basics of the braking features. The helicopter 100 comprises a motor 120, a main gear box 130, a rotor blade 140, a rotor brake 150, a tail rotor shaft 160, and a tail rotor 170. The rotor brake 150 may apply nominal braking or emergency braking to decrease the speed of the rotor blade 140.

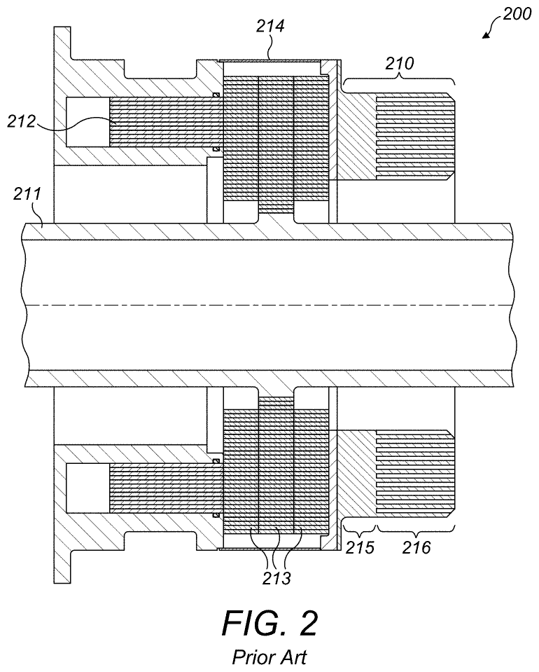

FIG. 2 shows a known brake calliper 200 with a heatsink 210 installed. As shown in FIG. 2, the brake calliper 200 includes a shaft 211 connected to a rotor (for example, the rotor blades 140 of FIG. 1), pistons 212 to apply a braking force to discs 213 so as to cause braking of the rotor (for example, the rotor blades 140 of FIG. 1). A housing 214 is provided to surround the pistons 212 and discs 213. The heatsink 210 includes a base 215 and fins 216. The heatsink 210 allows for thermal energy to dissipate through the base 215 and fins 216 during emergency braking of the helicopter. However, as emergency situations are very rare, it is typical that the helicopter only experiences nominal braking in daily use. Nominal braking uses roughly a quarter of the energy of emergency braking and, therefore, the heatsink 210 of the brake calliper 200 is oversized for everyday use.

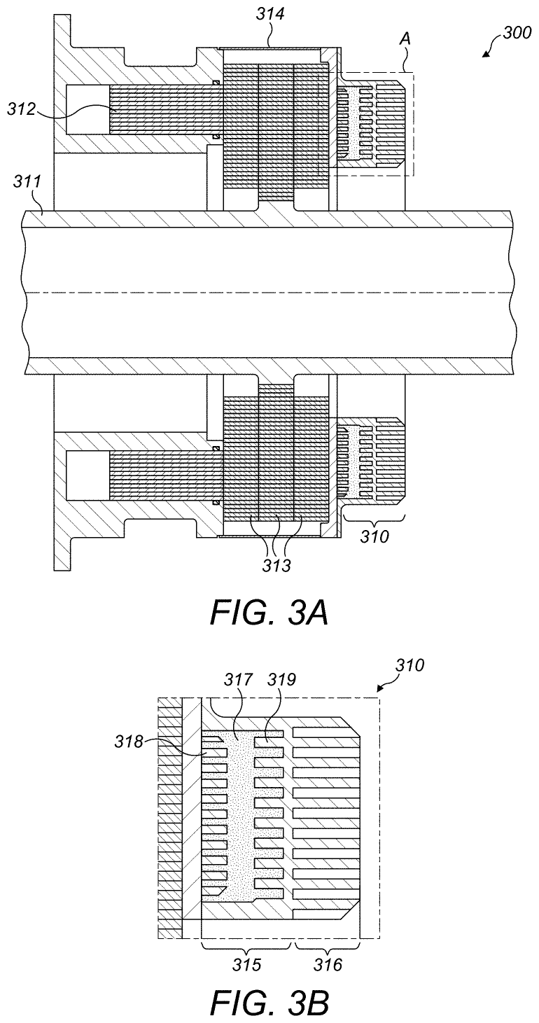

FIG. 3A shows an example of a new brake calliper 300. As shown in FIG. 3A, the brake calliper 300 includes a shaft 311 connected to a rotor (for example, the rotor blades 140 of FIG. 1), pistons 312 to apply a braking force to discs 313 so as to cause braking of the rotor (for example, the rotor blades 140 of FIG. 1). A refractory housing 314 is provided to surround the pistons 312 and discs 313. Heatsink 310 is shown in FIG. 3A and a portion A is depicted in FIG. 3B.

FIG. 3B shows an example of a new heatsink 310 that can be installed in a braking system 300 (shown in FIG. 3A). The heatsink 310 may include a hollow base 315 and cooling fins 316 that are external to the base 315. An intermediate material 317 may be provided within the hollow base 315. Optionally, in addition, the base 315 may include internal fins 318 and 319 which extend into the intermediate material 317.

The intermediate material 317 may be specifically chosen such that the intermediate material 317 has a melting temperature that is below the temperature required to ignite fluid, but above the temperature of the environment surrounding the heatsink 310 during normal operation. As an example, the melting temperature of the intermediate material 317 is above 520 Kelvin and below 575 Kelvin. The intermediate material 317 may consist of metallic alloy, for example Tin and antimony of tin having a melting point between 520 Kelvin to 573 Kelvin pending to tin percentage from 8% to 12%, polymer, for example Nylon 6-6 having a melting point of 537 Kelvin, or chemical salt.

As the intermediate material 317 has a melting temperature that is above the temperature of the environment of the heatsink 310 during normal operation, when normal (nominal) braking is applied, the intermediate material 317 remains solid and heat (i.e., thermal energy) is transferred through the intermediate material 317 to the cooling fins 316 where the thermal energy is dissipated.

The intermediate material 317 also may have a melting temperature that is below the temperature that ignites hydraulic fluid. Therefore, when the temperature of the brake rises above the normal operational temperature, for example during emergency braking, the intermediate material 317 begins to melt. As mentioned above, during emergency braking, the amount of energy that needs to be dissipated is approximately four times greater than the energy to be dissipated during normal braking (and normal operation). During the melting of the intermediate material 317, and due to latent heat fusion, the intermediate material 317 absorbs the thermal energy. Therefore, the temperature does not increase any further while the intermediate material 317 is still melting and the fluid never reaches a temperature at which it ignites. In addition, the cooling fins 316 may also dissipate thermal energy transferred from the intermediate material 317 during the melting process.

The hollow base 315 may also include a first plurality of internal fins 318 and a second plurality of internal fins 319 that extend radially inward, for example, from the hollow base 315 and into the intermediate material 317. In order to ensure efficient heat dissipation, the heat generated by the discs 313 during braking should be transmitted to the base 315 as soon as possible. The higher the thermal gradient between the base 315 and the brake environment, the more efficient the cooling fins 316 will be. The refractory housing 314 avoids heat transfer out of the system. Therefore, braking energy is mainly transmitted to the base 315.

Further, the first and second plurality of internal fins 318 and 319 improve heat transfer. The first plurality of internal fins 318 extend from a first side of the base 315 closest to the discs 313, in use. The first plurality of internal fins 318 improve heat transfer from discs 313 to the intermediate material 317. The first plurality of internal fins 318 allow the intermediate material 317 to increase in temperature as homogeneously as possible. The second plurality of internal fins 319 extend from the base 315 into the intermediate material 317 on a second side of the base 315 closest to the cooling fins 316. The second plurality of internal fins 319 improve heat transfer from the intermediate material 317 to the cooling fins 316.

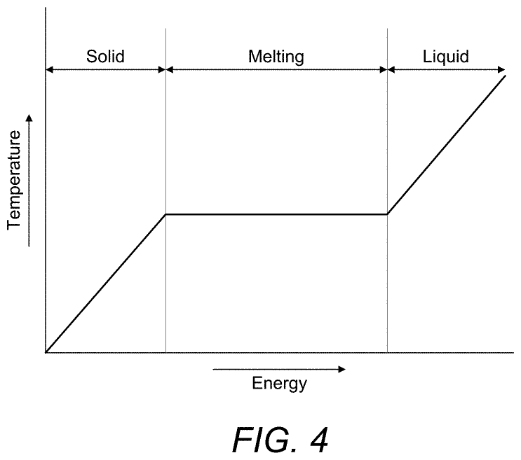

FIG. 4 shows an example graph of latent heat fusion of the intermediate material 317. As can be seen in this graph, as temperature rises in the ‘solid’ phase, the amount of energy absorbed increases. During the ‘melting’ phase, the amount of energy absorbed increases over time but there is no temperature rise. Therefore, in this example, the intermediate material 317 allows the temperature to remain the same during the ‘melting’ phase so that, provided the intermediate material 317 does not completely melt, any fluid is not ignited during emergency braking. Further, as significant energy is absorbed through the intermediate material 317, the cooling fins 316 may be significantly reduced in size and the heatsink 310 is less bulky than those used in known systems—for example, as shown in FIG. 2.

The heatsink 310 shown in FIG. 3 may also be used as a replaceable component and can be installed as a replacement to a heatsink 210 shown in FIG. 2. The heatsink 310, for example, could be used in the brake calliper 200 of FIG. 2.

Although this disclosure has been described in terms of preferred examples, it should be understood that these examples are illustrative only and that the claims are not limited to those examples. Those skilled in the art will be able to make modifications and alternatives in view of the disclosure which are contemplated as falling within the scope of the appended claims.

1. A heatsink for a brake calliper, said heatsink comprising;
a hollow base; and
an intermediate material provided in the hollow base.

2. The heatsink of claim 1, further comprising a plurality of cooling fins located adjacent the hollow base.

3. The heatsink of claim 1, wherein, in use, the intermediate material is configured to melt above a temperature of the environment during normal braking operation and below a temperature of the environment during emergency braking operation so as to absorb thermal energy.

4. The heatsink of claim 3, wherein the melting temperature of the intermediate material is above 520 Kelvin and below 575 Kelvin.

5. The heatsink of claim 1, wherein the intermediate material is at least one of: a metallic alloy; polymer; or chemical salt.

6. The heatsink of claim 1, wherein the hollow base is surrounded by a refractory housing.

7. The heatsink of claim 1, further comprising internal fins extending into the intermediate material.

8. A brake calliper, said brake calliper comprising;
a rotor blade;
a shaft connected to the rotor blade;
a rotor brake connected to the shaft; and
a heatsink as claim 1, connected to the rotor brake.

9. The brake calliper of claim 8, the brake calliper further comprising:
a plurality of discs adjacent a first side of the hollow base;
a plurality of cooling fins adjacent a second side of the hollow base;
a first plurality of internal fins extending into the intermediate material from the first side of the hollow base; and
a second plurality of internal fins extending into the intermediate material from the second side of the hollow base.

10. A method of transferring thermal energy from a brake calliper during an emergency brake operation, the method comprising:
providing a heatsink, said heatsink comprising a hollow base; and
providing an intermediate material in the hollow base, wherein, during an emergency brake operation, the intermediate material melts to absorb thermal energy from the brake calliper.

11. The method of claim 10, wherein the intermediate material melts above a temperature of the environment during normal braking operation and below a temperature of the environment during emergency braking operation to absorb thermal energy.

12. The method of claim 11, wherein the melting temperature of the intermediate material is above 520 Kelvin and below 575 Kelvin.

13. The method of claim 11, wherein the intermediate material is at least one of a metallic alloy, polymer and/or chemical salt.

14. The method of claim 11, wherein the hollow base is surrounded by a refractory housing.

15. The method of claim 11, wherein the heatsink further comprises internal fins extending into the intermediate material.
